(19) United States
(12) Patent Application Publication
(10) Pub. No.: US 2013/0342098 A1
(43) Pub. Date: Dec. 26, 2013

(54) Corrugated Dielectric for Reliable High-current Charge-emission Devices

(71) Applicants: Christopher E. Holland, San Jose, CA (US); Charles A. Spindt, Menlo Park, CA (US)

(72) Inventors: Christopher E. Holland, San Jose, CA (US); Charles A. Spindt, Menlo Park, CA (US)

(73) Assignee: SRI INTERNATIONAL, MENLO PARK, CA (US)

(21) Appl. No.: 14/000,418

(22) PCT Filed: Mar. 13, 2012
(86) PCT No.: PCT/US12/28851

§ 371 Date: Aug. 20, 2013

Related U.S. Application Data
(60) Provisional application No. 61/453,985, filed on Mar. 18, 2011.

(51) Int. Cl. H01J 1/88; H01J 9/02

(52) U.S. Cl. CPC H01J 1/88; H01J 9/025
USPC 313/310; 445/51

(57) ABSTRACT

Micro-fabricated charge-emission devices comprise an electrically conductive gate electrode with an aperture, an electrically conductive base electrode, a charge-emitting microstructure extending from a surface in electrical contact with the base electrode and terminating near the aperture of the gate electrode, and a dielectric layer stack disposed between the base electrode and the gate electrode. The dielectric layer stack comprises a first dielectric layer and a second dielectric layer. The first dielectric layer is disposed between the second dielectric layer and the base electrode. The first dielectric layer is of a different selectively etchable dielectric material than the second dielectric layer. The dielectric layer stack h formed therein a cavity within which the charge-emitting emitting microstructure is disposed. The cavity has a corrugated wall shaped by the first dielectric layer undercutting the second dielectric layer. The corrugated wall surrounds the charge-emitting microstructure disposed within the cavity.

### RELATED APPLICATION

This application claims priority to and the benefit of U.S. provisional application No. 61/453,985, filed on Mar. 18, 2011, titled “Corrugated Dielectric for Reliable High-current Spindt Cathode Design,” the entirety of which application is incorporated by reference herein.

### FIELD OF THE INVENTION

The invention relates generally to micro-fabricated charge-emission devices and methods of fabrication.

### BACKGROUND

Micro-fabricated charge-emission devices, known as Spindt cathodes, have shown remarkable potential as high-current density cold cathodes for a variety of applications, including, but not limited to, flat panel displays, spacecraft charge management, x-ray generation, field ion generation and RF vacuum electronic systems. The reliability of such devices, however, has been less than optimal because of random breakdown across the dielectric surface between the gate and substrate electrodes.

### SUMMARY

In one aspect, the invention relates to a micro-fabricated charge-emission device comprising an electrically conductive gate electrode with an aperture, an electrically conductive base electrode, a charge-emitting microstructure extending from a surface in electrically conductive contact with the base electrode and terminating near the aperture of the gate electrode, and a dielectric layer stack disposed between the base electrode and the gate electrode. The dielectric layer stack comprises a first dielectric layer and a second dielectric layer. The first dielectric layer is disposed between the second dielectric layer and the base electrode. The first dielectric layer is of a different selectively etchable dielectric material than the second dielectric layer. The dielectric layer stack has formed therein a cavity within which the charge-emitting microstructure is disposed. The cavity has a corrugated wall shaped by the first dielectric layer undercutting the second dielectric layer. The corrugated wall surrounds the charge-emitting microstructure disposed within the cavity.

In another aspect, the invention relates to a method of fabricating a charge-emission device. A dielectric layer stack is formed on a conductive substrate. The dielectric layer stack includes a first dielectric layer and a second dielectric layer disposed on the first dielectric layer.

The first dielectric layer is of a different selectively etchable dielectric material than the second dielectric layer. A cavity is formed within the dielectric layer stack to expose a surface that is in electrically conductive contact with the conductive substrate. A charge-emitting microstructure is formed on the surface in the cavity. The dielectric layer stack is selectively etched within the cavity such that the first dielectric layer undercuts the second dielectric layer and forms a corrugated wall that surrounds the charge-emitting microstructure in the cavity.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is a cross-section diagram of an embodiment of a prior art charge-emission device having a gate and an array of emitters.

FIG. 2 is a side section view of another embodiment of a charge-emission device having a corrugated cavity wall surrounding an emitter for eliminating or mitigating the occurrence of flashover events experienced by the prior art charge-emission device of FIG. 1.

FIG. 3 is an elevated sectional view of the charge-emission device of FIG. 2.

FIG. 4 is a SEM photograph of an elevated view of an array of charge-emission devices with corrugated cavity walls.

FIG. 5 is a SEM photograph of a side section view of the charge-emission device of FIG. 2, without the emitter.

FIG. 6 is a SEM photograph of an elevated section view of the charge-emission device of FIG. 2, without the emitter.

FIG. 7 is a SEM photograph of a side section view of the charge-emission device of FIG. 2, with the emitter.

FIG. 8 is a flow diagram of an embodiment of a fabrication process for fabricating a charge-emission device with a corrugated dielectric-layer-stack wall (also referred to as a cavity wall).

### DETAILED DESCRIPTION

Applicants recognized that breakdowns of charge-emission devices, conventionally attributed to tip explosions, are actually the result of a flashover along the dielectric sidewalls of the cavities within which the emitters reside. Flashover is, in general, a surface avalanche breakdown along the sidewall that produces a short circuit path between the gate electrode and the base electrode. The flashover likely initiates at the “triple point” between the insulating oxide, silicon base electrode, and a vacuum in the base of the cavity or due to spurious electron bombardment on same oxide.

As described herein, the applicants address the problem of flashover by adding another dielectric layer between the gate electrode and the insulating oxide layer to insulate the gate electrode further from the base electrode. The added dielectric layer is of a different dielectric material than the oxide. Further, the added dielectric layer and the oxide layer are selectively etchable with respect to each other. Selective etching operates to produce a corrugated or discontinuous stepped profile on the surface of the cavity wall. In one embodiment, the oxide layer is selectively etched to undercut the added dielectric layer. The stepped profile of the cavity wall operates to disrupt the direct avalanche breakdown path between the gate electrode and the base electrode by hiding the gate electrode from the sidewall of the oxide layer.

Preferably, the charge-emission devices described herein have a stack with multiple steps of dielectric layers between the gate and base electrodes. The dielectric layer at the top of the dielectric layer stack, immediately below the gate electrode, has an aperture with a diameter of a size optimized for fabricating the emitter cone in the cavity using a standard Spindt cathode fabrication process. The diameter of this aperture can be smaller than the aperture in the gate electrode, to provide additional “shielding” from an avalanche breakdown between the base and gate electrodes.

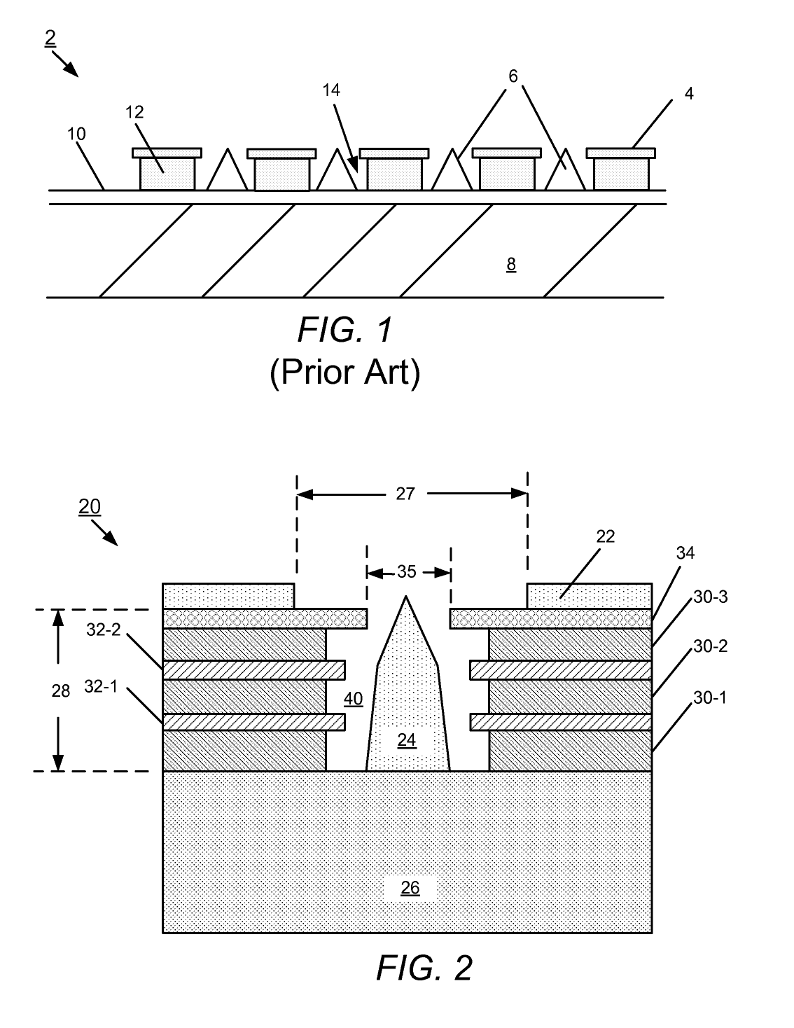

FIG. 1 shows a diagram of a cross-section of a prior art charge-emission device 2 having a gate 4 and an array of emitters 6. Charge-emission devices, as used herein, include electron field emission device, field emission devices, and ion emission devices. One example of the charge-emission device 2 is a Spindt cathode device, manufactured by SRI International of Menlo Park, Calif. and described in U.S. Pat. No. 3,789,471, issued to Spindt et al, on Feb. 5, 1974. In general, the current emission level of the charge-emission device 2 is controlled by adjusting the voltage of the gate 4 relative to the tips of the emitters 6. Because of the small scales of geometry of the gate 4 and emitters 6, operating voltages for controlling current emission from each emitter tip 6 can range typically between 30 volts and 100 volts. Thus, the charge-emission device 2 has an advantage of being efficient at generating electrons while requiring low electrical power. More specifically, applying an operating voltage above a threshold induces the emitter tips to emit electrons; further increasing this voltage causes an increase in the emitted current.

The charge-emission device 2 is fabricated on a substrate 8 that is typically, but not limited to, a semiconductor (e.g., silicon) or a metal coated insulator (e.g., glass). The substrate 8 may include an upper resistive layer 10 (e.g. resistivity on the order of 100 M-ohms) to improve uniformity of emission from the emitters 6 in the array. Although a higher drive voltage becomes necessary to achieve comparable emission current, the resistive layer 10 provides significant failure protection on an emitter tip-by-tip basis and increases field emission device reliability and emitter tip longevity. An insulating oxide layer 12 (e.g., silicon dioxide) covers the substrate 8 (or the resistive layer 18).

A conducting film (e.g., molybdenum) coats the insulating oxide layer 12. This conducting film can be a metal, a resistive material, or a semiconductor. An array of holes (or cavities) 14 is etched through the conducting film and the insulating layer 12 to the substrate 8 (or to the resistive layer 10) using semiconductor manufacturing techniques. The conducting film remaining after the etching of the holes forms the gate 4 of the charge-emission device 2.

Emitters 6 comprised of conducting material (e.g., molybdenum) are formed in the cavities 14. In one embodiment, the base of each emitter 6 is on the substrate 8 (or on the resistive layer 10) and the tip of each emitter 6 is in the plane of the gate 4. The tip aspect ratio, its length and width, and the shape can be designed to tailor the characteristics of the device 2. For those embodiments having a resistive layer 10, each emitter tip behaves effectively as if in series with a resistor.

FIG. 2 shows an embodiment of a charge-emission device 20 having features that eliminate or mitigate the occurrence of cavity wall flashover experienced by the prior art charge-emission devices of FIG. 1. The charge-emission device 20 includes a gate 22 and an emitter 24 formed on a conductive substrate 26, also referred to as a base electrode 26. The gate 22 has an aperture 27 formed therein. Although only one emitter is shown to simplify the description, charge-emission devices can have arrays with any pattern distribution and can contain many emitters as necessary for the application (e.g. 25,000 emitters in 1 m diameter area). The particular cone-like or obelisk-like shape of the emitter 24 shown in FIG. 2 is not intended to be a limitation of the principles described herein; such principles can extend to charge-emission devices with differently shaped emitters.

Disposed between the gate 22 and base electrode 26 is an insulating layer 28, herein referred to as dielectric layer stack 28. In one embodiment, the dielectric layer stack comprises a first oxide layer 30-1 on the surface of the base electrode 26 (or on a resistive layer formed on the base electrode), a first oxinitride layer 32-1 on the first oxide layer 30-1, a second oxide layer 30-2 on the first oxinitride layer 32-1, a second oxinitride layer 32-2 on the second oxide layer 30-2, a third oxide layer 30-3 on the second oxinitride layer 32-2, and a nitride shield layer 34 on the third oxide layer 30-3. In one embodiment, the oxide layers 30-1, 30-2, and 30-3 (generally, 30) comprise silicon dioxide (SiO₂), the oxinitride layers 32-1, 32-2, and 32-3 (generally, 32) comprise silicon oxinitride (SiON), and the nitride shield layer 34 comprises silicon nitride (Si₃N₄). Although described herein with a particular number of layers and certain types of materials, the principles of the invention extend to any number of layers and material types, provided they produce a discontinuous path in the cavity wall in order to suppress electron surface avalanche.

This nitride shield layer 34 has an aperture 35 concentric with the gate aperture 27 and can be as shown of a smaller diameter than the gate aperture 27. The diameter of the aperture 35 in the nitride shield layer 34 can be designed to be of a size optimal for fabricating the emitter 14 in the cavity 40 by the standard Spindt cathode process. To facilitate fabrication, the nitride shield layer 34 is selectively etchable with respect to the other materials in the dielectric layer stack 28.

The dielectric layer stack 28 has parallel and alternating ridges and grooves (described herein as corrugated, without any loss of generality), wherein the first oxide layer 30-1 undercuts the first oxinitride layer 32-1, the second oxide layer 30-2 undercuts the second oxinitride layer 32-2, and the third oxide layer 30-3 undercuts the nitride shield layer 34. Although shown in FIG. 2 to be substantially equal, the extent of undercutting by the oxide layers 30-1, 30-2 can be unequal. Etched back from the diameter of the nitride layer 34, the oxide layers 30 of the cavity wall are effectively “hidden” from the gate electrode 22. This construction eliminates a direct path for surface breakdown to occur.

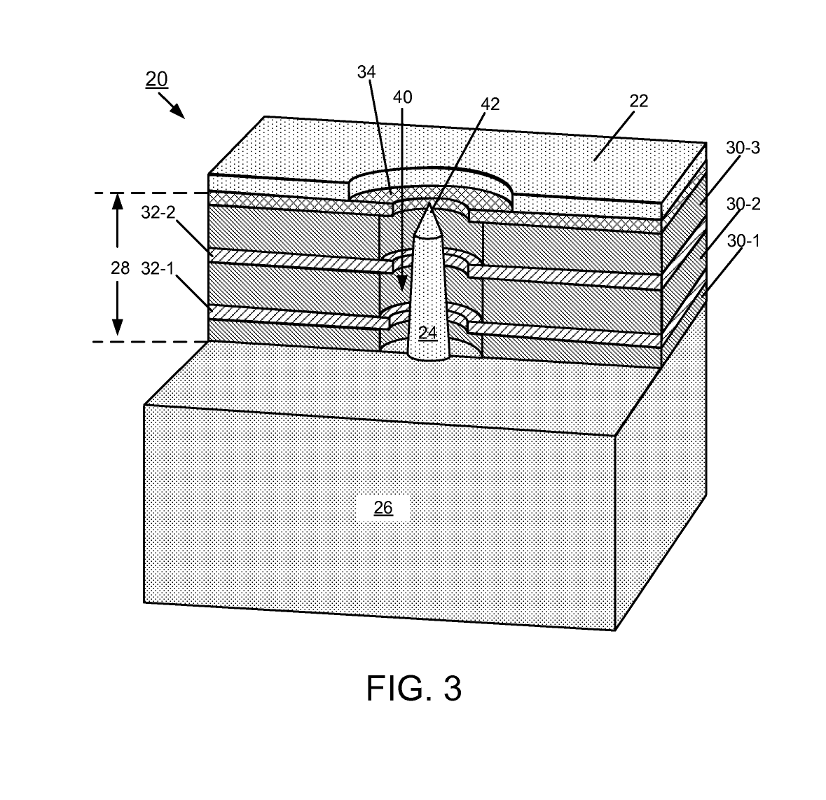

FIG. 3 shows an elevated sectional view of the charge-emission device 20. The view approximately bisects a cavity 40 formed in the dielectric layer stack 28. The cone-shaped emitter 24 in the cavity 40 extends from the surface of the conductive substrate 26 (or from a resistive layer, not shown, on the substrate) and narrows at a tip 42 near the aperture of the nitride shield layer 34 and gate layer 22. The cavity wall, extending from the surface of the conductive substrate 26 to the nitride shield layer 34, has the above-described corrugated or stepped profile, with the oxide layers 30 undercutting the oxinitride layers 32 and nitride shield layer 34 in the region of the cavity 40.

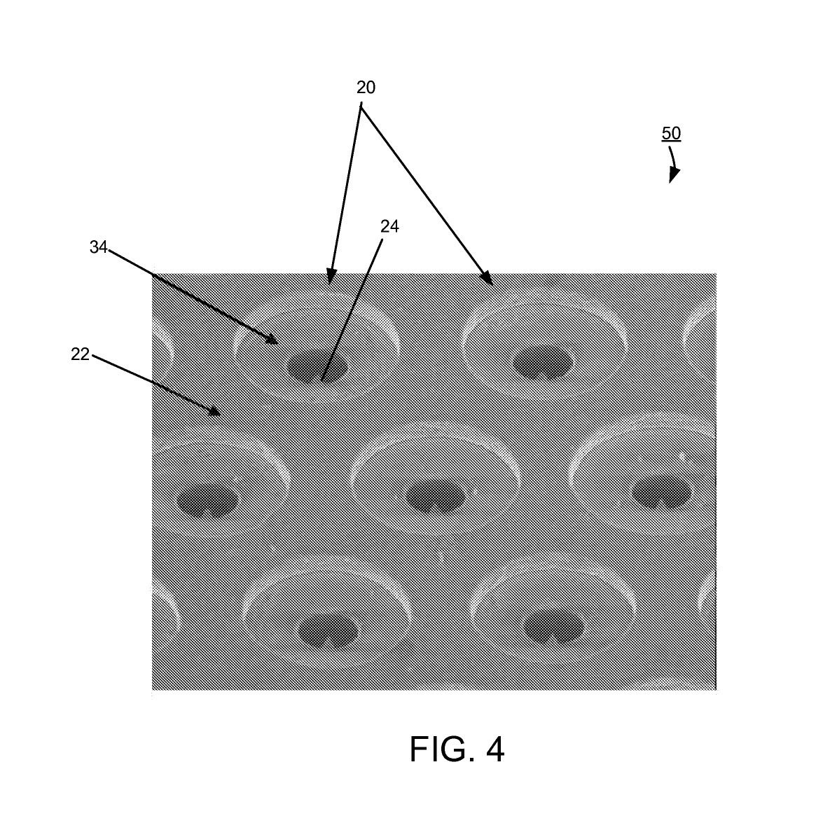

FIG. 4 shows a SEM micrograph of an array 50 of charge-emission devices 20 with the nitride shield layer 34 of each device 20 extending from under the gate electrode 22. The emitter 24 is visible within the aperture of the nitride shield layer 34. The insulating dielectric layer stack 28 below the nitride layer 34 is etched back under the nitride shield layer 34 and is not visible.

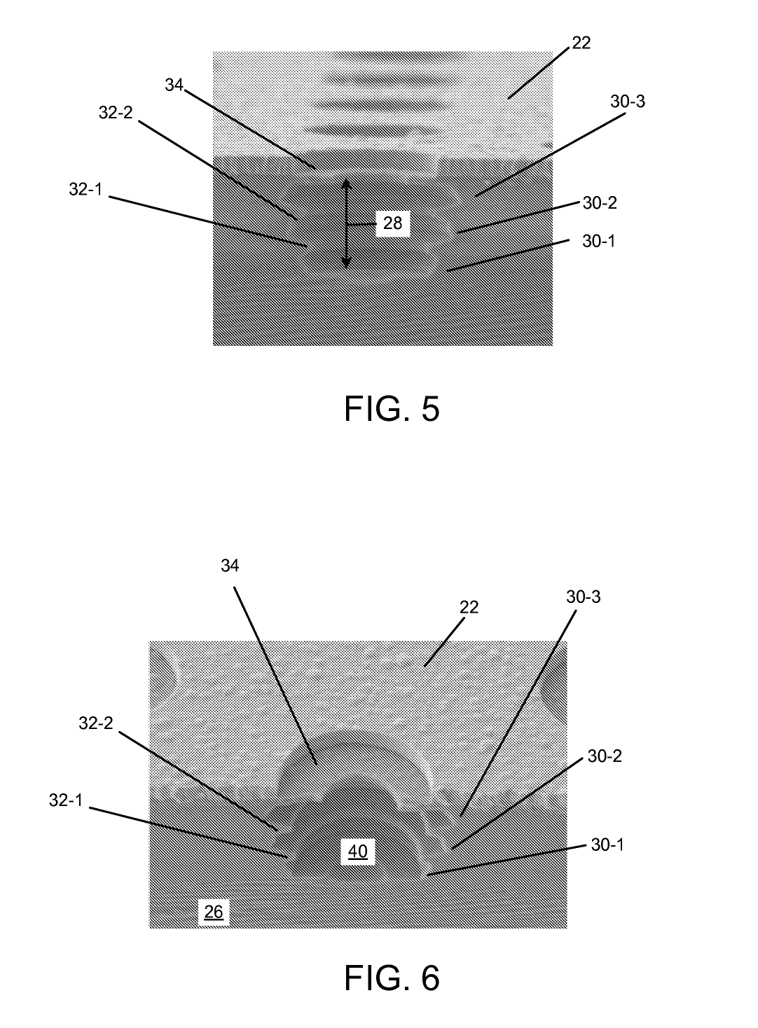

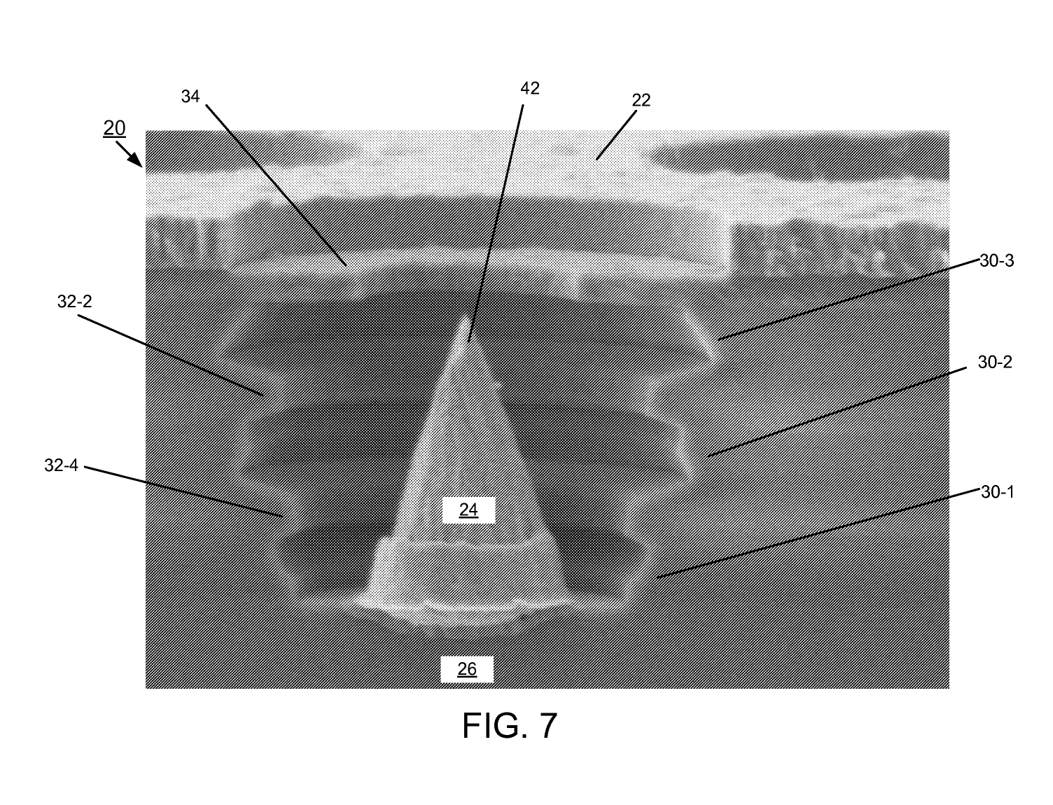

FIG. 5 and FIG. 6 are SEM micrographs showing example section views of a dielectric layer stack 28 in the region of the cavity 40. The emitter is absent to allow an unobstructed view of the corrugated cavity wall comprised of alternating layers of oxide 30-1, 30-2, 30-3 and oxinitrides 32-1 and 32-2. The top layer of the dielectric layer stack 28 is the nitride shield layer 34. The extent of etching can vary among layers, with the upper oxide 30 and oxinitride layers 32, in general, being etched back farther than the lower layers. FIG. 7 is a SEM photograph of a section side view of a charge-emission device 20 with the emitter 24 rising from the base electrode 26 and narrowing to a tip 42 just below the level of the nitride shield layer 34.

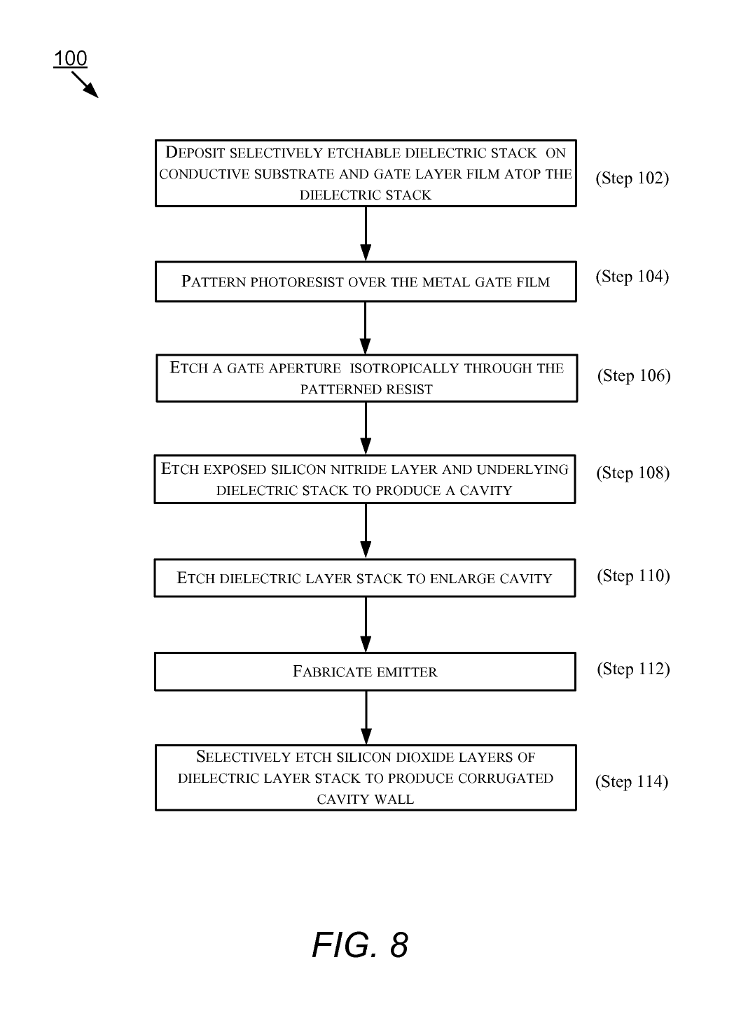

FIG. 8 shows one embodiment of a fabrication process 100 for fabricating a charge-emission device 20 with a corrugated dielectric-layer stack (i.e., cavity) wall. In the description of the process, reference is also made to elements shown in FIGS. 2 and 3. The fabrication process 100 includes depositing (step 102) a selectively etchable dielectric stack 28 (e.g. silicon dioxide (SiO₂), silicon oxinitride (SiON), and silicon nitride (Si₃N₄)) on the conductive substrate (i.e. base electrode) 26 and a metal gate film 22 atop the dielectric layer stack 28. Low-pressure chemical vapor deposition (LPCVD) is one technique that can be used to deposit the dielectric layers 30, 32, and 34 of the dielectric layer stack 28. A photoresist is patterned (step 104) over the metal gate film 22. A gate aperture 27 is etched (step 106) isotropically through the patterned resist, undercutting the photoresist at the edges of the patterned opening. The exposed nitride shield layer 34 and underlying oxinitride layers 32 and oxide 30 are then etched (step 108) with an anisotropic reactive ion etching process that defines the cavity 40 in the dielectric layer stack 28. The formed aperture 35 in the nitride shield layer 34 opens into the cavity 40. The oxinitride layers 32 and oxide 30 of the dielectric layer stack 28 are then isotropically selectively etched (step 110) through the nitride aperture 35 using, for example, 10:1 H₂O:HF, moving the cavity wall back away from the nitride aperture 35 and distancing the cavity wall from the metal gate 22. The emitter 24 is fabricated (step 112) on the conductive surface of the base electrode 26. After emitter fabrication, the oxide 30 layers of the dielectric layer stack 28 are selectively further undercut (step 114) using, for example, buffered HF, to create the corrugated features of the cavity wall. As previously described, the corrugated cavity wall diminishes the conditions requisite for a flashover avalanche breakdown from the base electrode 26 to the gate 22 along the cavity wall, because the gate 22 is not in a direct (i.e., generally linear) path from the above-described triple point.

The process described in FIG. 8 is just one example of a technique for fabricating charge-emission devices; the principles described herein extend to charge-emission devices fabricated using other techniques, for example, to charge-emission devices fabricated by first forming the emitter, then fabricating the dielectric cavity around the emitter, and then the gate.

Reference in the specification to “one embodiment” or “an embodiment” means that a particular, feature, structure or characteristic described in connection with the embodiment is included in at least one embodiment of the teaching. References to a particular embodiment within the specification do not all necessarily refer to the same embodiment.

The flowchart in the Figures illustrates the functionality and operation of a possible implementation of a fabrication process according to one embodiment. It should be noted that, in some alternative implementations, the functions noted in the steps may occur out of the order noted in the Figures. For example, two steps shown in succession may, in fact, be executed substantially concurrently, or the steps may sometimes be executed in the reverse order, depending upon the functionality involved (e.g., the dielectric stack is deposited after the emitter has been fabricated).

While the invention has been shown and described with reference to specific preferred embodiments, it should be understood by those skilled in the art that various changes in form and detail may be made therein without departing from the spirit and scope of the invention as defined by the following claims.

What is claimed is:

1. A micro-fabricated charge-emission device comprising:
an electrically conductive gate electrode with an aperture;
an electrically conductive base electrode;
a charge-emitting microstructure extending from a surface in electrically conductive contact with the base electrode and terminating near the aperture of the gate electrode; and
a dielectric layer stack disposed between the base electrode and the gate electrode, the dielectric layer stack comprising a first dielectric layer and a second dielectric layer, the first dielectric layer being disposed between the second dielectric layer and the base electrode, the first dielectric layer being of a different selectively etchable dielectric material than the second dielectric layer, the dielectric layer stack having formed therein a cavity within which the charge-emitting microstructure is disposed, the cavity having a corrugated wall shaped by the first dielectric layer undercutting the second dielectric layer, the corrugated wall surrounding the charge-emitting microstructure disposed within the cavity.

2. The device of claim 1, wherein the first dielectric layer is an oxide layer adjacent to the surface that is in electrically conductive communication with the base electrode.

3. The device of claim 2, wherein the second dielectric layer is an oxinitride layer adjacent to the first dielectric layer.

4. The device of claim 1, wherein the dielectric layer stack further comprises a third dielectric layer disposed on the second dielectric layer and a fourth dielectric layer disposed on the third dielectric layer, the corrugated wall of the cavity being further shaped by the third dielectric layer undercutting the fourth dielectric layer.

5. The device of claim 4, wherein the first and third dielectric layers are oxide layers and the second and fourth dielectric layer are oxinitride layers.

6. The device of claim 5, wherein the oxinitride layers comprise SiON.

7. The device of claim 4, wherein the dielectric layer stack further comprises a fifth dielectric layer disposed on the fourth dielectric layer and a sixth dielectric layer disposed on the fifth dielectric layer, the corrugated wall of the cavity being further shaped by the fifth dielectric layer undercutting the sixth dielectric layer.

8. The device of claim 7, wherein the sixth dielectric layer is adjacent to the conductive gate electrode.

9. The device of claim 7, wherein the first, third, and fifth dielectric layers are oxide layers, the second and fourth dielectric layers are oxinitride layers, and the sixth dielectric layer is a nitride layer.

10. The device of claim 7, wherein the sixth dielectric layer has an aperture into the cavity that is smaller in diameter than the aperture of the gate electrode.

11. A method of fabricating a charge-emission device comprising:
fabricating a dielectric layer stack on a conductive substrate, the dielectric layer stack including a first dielectric layer and a second dielectric layer disposed on the first dielectric layer, the first dielectric layer being of a different selectively etchable dielectric material than the second dielectric layer.
forming a cavity within the dielectric layer stack to expose a surface that is in electrically conductive contact with the conductive substrate;
forming a charge-emitting microstructure on the surface in the cavity; and
selectively etching the dielectric layer stack within the cavity such that the first dielectric layer undercuts the second dielectric layer and forms a corrugated wall that surrounds the charge-emitting microstructure in the cavity.

12. The method of claim 11, wherein the first dielectric layer is an oxide layer adjacent to the surface that is in electrically conductive communication with.

13. The method of claim 12, wherein the second dielectric layer is an oxinitride layer adjacent to the first dielectric layer.

14. The method of claim 11, wherein fabricating a selectively etchable dielectric layer stack includes forming a third dielectric layer on the second dielectric layer and a fourth dielectric layer on the third dielectric layer, and wherein etching the dielectric layer stack includes undercutting the fourth dielectric layer with the third dielectric layer.

15. The method of claim 14, wherein the first and third dielectric layers are oxide layers and the second and fourth dielectric layer are oxinitride layers.

16. The method of claim 15, wherein the oxinitride layers comprise SiON.

17. The method of claim 14, wherein fabricating a selectively etchable dielectric layer stack includes forming a fifth dielectric layer on the fourth dielectric layer and a sixth dielectric layer on the fifth dielectric layer, wherein etching the dielectric layer stack includes undercutting the six dielectric layer with the fifth dielectric layer.

18. The method of claim 17, wherein the sixth dielectric layer is adjacent to the conductive gate electrode.

19. The method of claim 17, wherein the first, third, and fifth dielectric layers are oxide layers, the second and fourth dielectric layers are oxinitride layers, and the sixth dielectric layer is a nitride layer.

20. The method of claim 17, wherein the sixth dielectric layer has an aperture into the cavity that is smaller in diameter than the aperture of the gate electrode.
